(19) United States
(12) Patent Application Publication
(10) Pub. No.: US 2007/0230889 A1
(43) Pub. Date: Oct. 4, 2007

(54) Plug-in unit

(75) Inventors: Yoshiyuki Sato, Kawasaki (JP); Mitsuo Fujimura, Kawasaki (JP)

Correspondence Address: BINGHAM MCCUTCHEN LLP, 2020 K Street, N.W., Intellectual Property Department, WASHINGTON, DC, 20006, US

(73) Assignee: FUJITSU LIMITED

(21) Appl. No.: 11/504,684

(22) Filed: Aug. 16, 2006

(30) Foreign Application Priority Data
Mar. 31, 2006 (JP) 2006-100587

(51) Int. Cl. G02B 6/00

(52) U.S. Cl. 385/135; 385/134

(57) ABSTRACT

A plug-in unit to be installed in a subrack and including on a front face at least one optical interface to which a fiber optic cable is connected includes an extra fiber optic cable length handling mechanism, positioned on the front face below the optical interface, for handling the fiber optic cable.

### BACKGROUND OF THE INVENTION

1. Field of the Invention

The present invention generally relates to a plug-in unit, and more particularly relates to a plug-in unit which is to be installed in a bookshelf-type subrack, and relates to an electronic apparatus including a bookshelf-type subrack in which multiple plug-in units are installed side by side and fiber optic cables coming into the electronic apparatus are connected to the plug-in units.

2. Description of the Related Art

There is a demand for a plug-in unit which is configured so as to accommodate many fiber optic cables and makes it easier to increase the number of lines in such an electronic apparatus as described above.

However, when many fiber optic cables are connected to sockets on the front face of a plug-in unit, it is troublesome to neatly store those fiber optic cables. Therefore, there is also a demand for a plug-in unit which can neatly and easily store fiber optic cables.

In a conventional electronic apparatus, plug-in units are installed in a subrack side by side, fiber optic cables coming into the electronic apparatus are connected to the plug-in units, and the fiber optic cables are stored inside a front cover of each plug-in unit. More specifically, fiber optic cables pass through the inside of the front cover and exit from a cable duct positioned in a lower part of the subrack.

[Patent document 1] Japanese Patent Application Publication No. 2002-50887

However, since the plug-in unit is configured to store fiber optic cables inside the front cover, it is difficult to increase the number of fiber optic cables connectable to the plug-in unit.

### SUMMARY OF THE INVENTION

The present invention provides a plug-in unit that substantially obviates one or more problems caused by the limitations and disadvantages of the related art.

According to an embodiment of the present invention, a plug-in unit to be installed in a subrack and including on a front face at least one optical interface to which a fiber optic cable is connected includes an extra fiber optic cable length handling mechanism, positioned on the front face below the optical interface, for handling the fiber optic cable.

A plug-in unit according to an embodiment of the present invention is configured to provide optical interfaces on its front face. This configuration makes it easier to increase the number of connectable fiber optic cables. Also, an extra fiber optic cable length handling mechanism provided in a plug-in unit according to an embodiment of the present invention makes it possible to neatly store fiber optic cables on the front face of the plug-in unit.

### BRIEF DESCRIPTION OF THE DRAWINGS

FIG. 1 is a perspective view of an electronic apparatus according to a first embodiment of the present invention;

FIG. 2 is a perspective view of an optical plug-in unit;

FIG. 3 is an exploded perspective view of the optical plug-in unit shown in FIG. 2;

FIGS. 4A and 4B are enlarged views of a portion close to the Y2 side of the optical plug-in unit shown in FIG. 3;

FIG. 5 is an enlarged view of a cage and an optical module shown in FIG. 4;

FIG. 6 is a perspective view of the optical plug-in unit with fiber optic cables connected;

FIG. 7 is an enlarged view of an extra fiber optic cable length handling mechanism shown in FIG. 6;

FIG. 8 is a perspective view of the optical plug-in unit where fiber optic cables are guided along a path by the extra fiber optic cable length handling mechanism;

FIG. 9 is an enlarged view of the extra fiber optic cable length handling mechanism shown in FIG. 8;

FIGS. 10A through 10D are drawings illustrating a first guiding member;

FIGS. 11A through 11D are drawings illustrating a second guiding member;

FIGS. 12A and 12B are drawings illustrating sequential operations of the extra fiber optic cable length handling mechanism;

FIGS. 13A and 13B are drawings illustrating the sequential operations of the extra fiber optic cable length handling mechanism, continued from FIG. 12B;

FIG. 14 is a perspective view of an optical plug-in unit according to a second embodiment of the present invention;

FIG. 15 is a drawing illustrating a second guiding member shown in FIG. 14;

FIGS. 16A and 16B are drawings illustrating sequential operations of an extra fiber optic cable length handling mechanism according to a second embodiment of the present invention;

FIGS. 17A and 17B are drawings illustrating the sequential operations of the extra fiber optic cable length handling mechanism, continued from FIG. 16B;

FIG. 18 is a perspective view of an optical plug-in unit according to a third embodiment of the present invention; and

FIG. 19 is an enlarged view of an extra fiber optic cable length handling mechanism shown in FIG. 18.

### DESCRIPTION OF THE PREFERRED EMBODIMENTS

Preferred embodiments of the present invention are described below with reference to the accompanying drawings.

### 1. First Embodiment

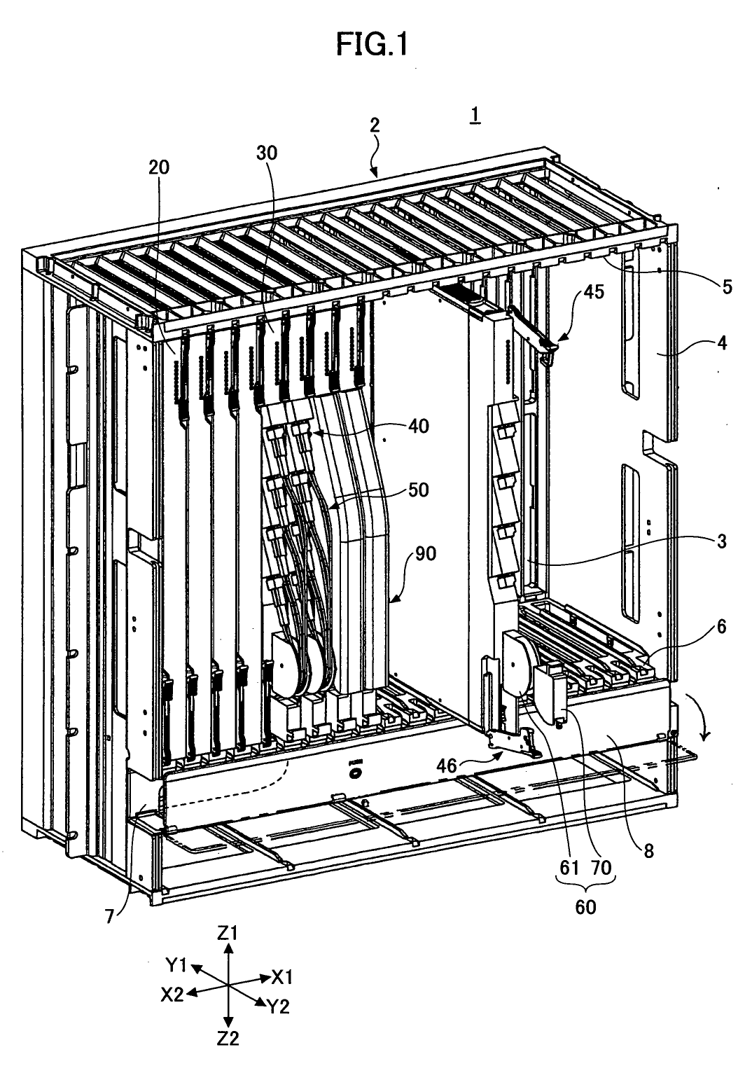

FIG. 1 is a perspective view of an electronic apparatus 1 according to the first embodiment of the present invention. Arrows X1-X2 show the width directions, Y1-Y2 show the depth directions, and Z1-Z2 show the height direction. The Y2 side is the front of the electronic apparatus 1.

The electronic apparatus 1 includes a subrack 2. In the subrack 2, plug-in units 20 having no optical interface and optical plug-in units 30 each having optical interfaces on its front face are installed side by side. Plug-in units are inserted into the subrack 2 from the Y2 side.

In FIG. 1, four optical plug-in units 30 are installed. Fiber optic cables are connected to two of the optical plug-in units 30 and are guided along corresponding paths. The other two optical plug-in units 30 are covered by protective covers. Also, in FIG. 1, another optical plug-in unit 30, to which no fiber optic cable is connected, is being inserted into the subrack 2.

The subrack 2 is box-shaped and includes on the back face a backplane 3 having an array of connectors (not shown), an insertion opening 4 at the Y2 side (front), upper guide rails 5, lower guide rail 6, and a duct 7 for fiber optic cables at the Y2 side near the Z2 side, stretching in the X1 and X2 directions. The Y2 side of the duct 7 is covered by an openable and closable cover 8.

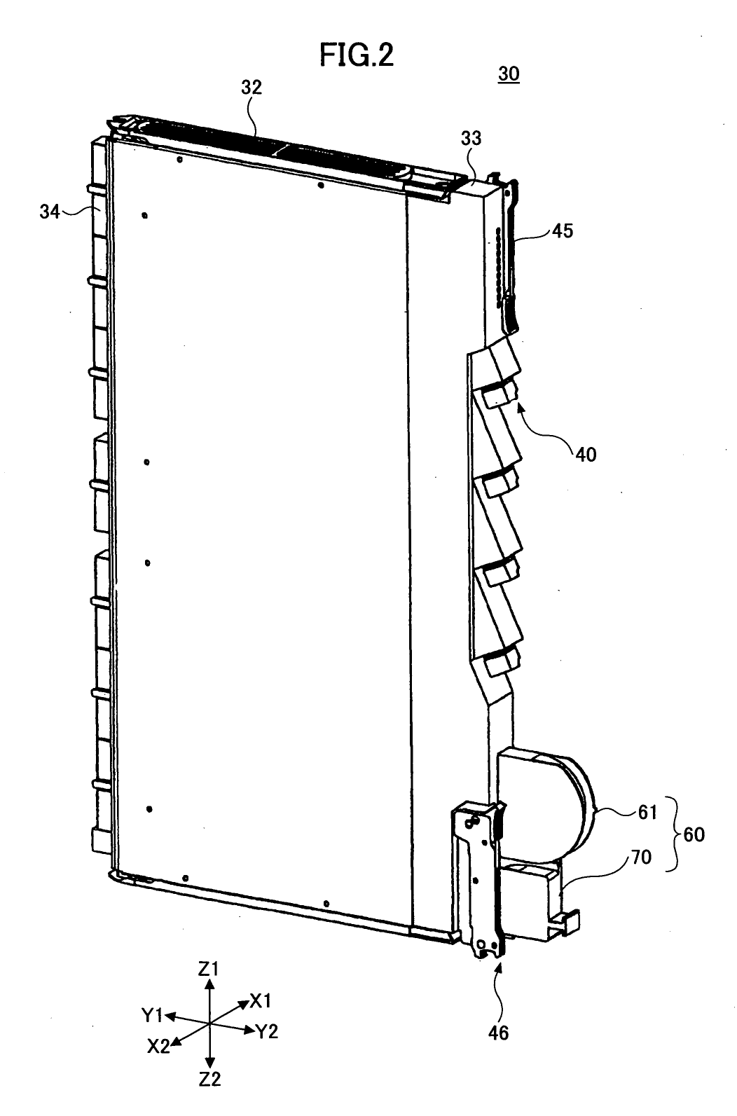

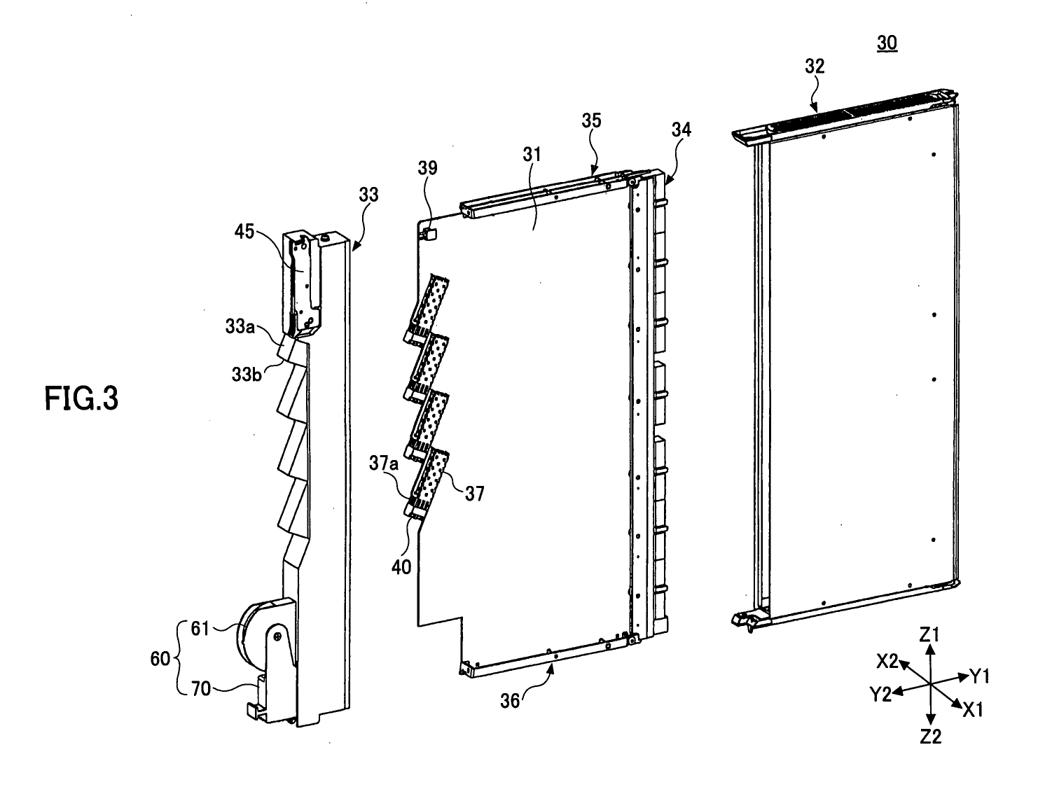

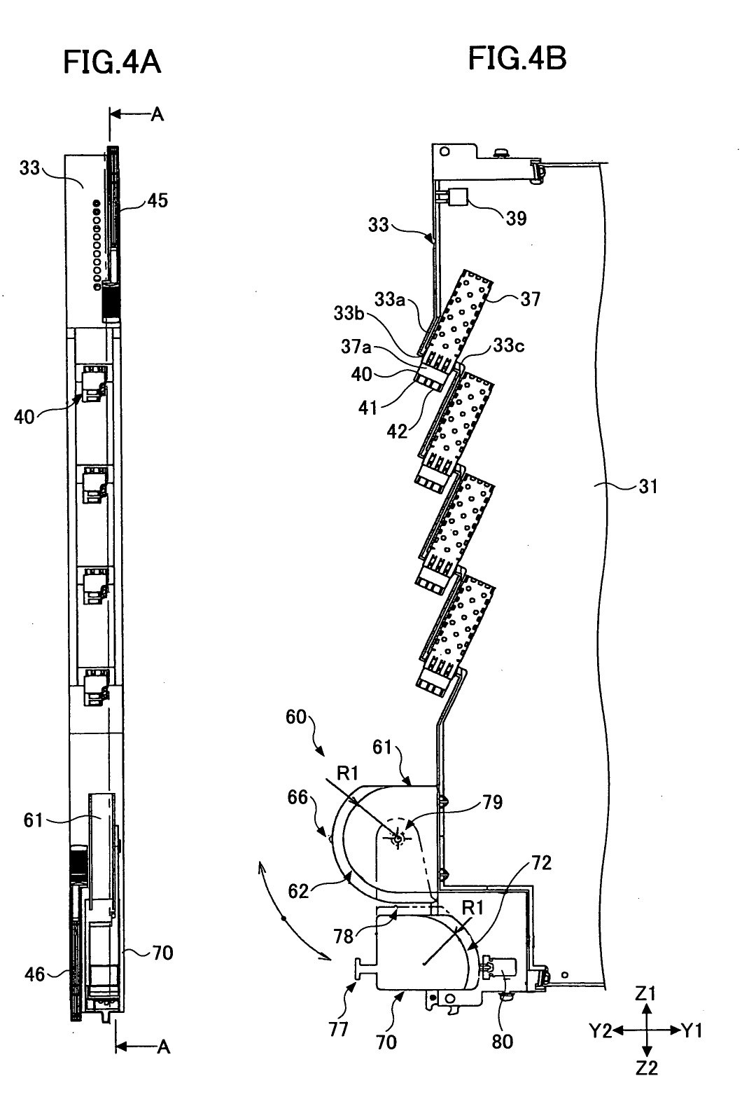

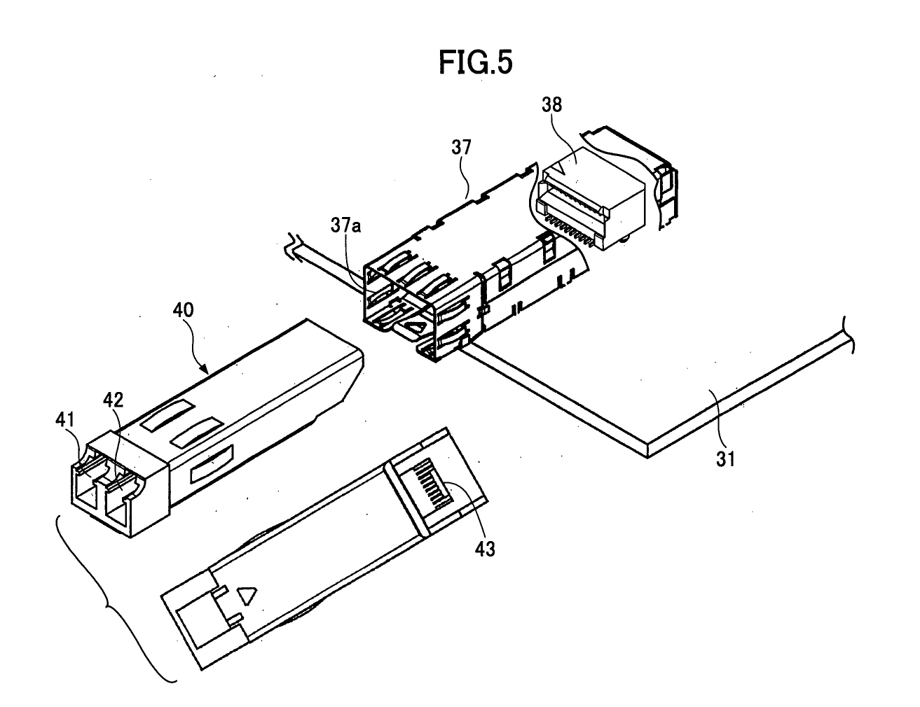

FIG. 2 is a perspective view of the optical plug-in unit 30 with no fiber optic cable connected, and FIG. 3 is an exploded perspective view of the optical plug-in unit 30. FIGS. 4A and 4B are enlarged views of a portion close to the Y2 side of the optical plug-in unit 30. As shown in FIG. 2 and FIG. 3, the optical plug-in unit 30 has a basic structure where a printed board 31 is encased in a flat housing made of a shield cover 32 and a front panel 33. The Y2 side is the front of the optical plug-in unit 30. The printed board 31 includes a connector 34 at the Y1 side, an arm 35 at the Z1 side, an arm 36 at the Z2 side, four cages 37 along the Y2 side edge, an LED 39, and other electronic components (not shown). Each cage 37 encases a connector 38 (shown in FIG. 5) and is fixed to the printed board 31 so that an insertion opening 37a faces obliquely downward.

FIG. 5 is an enlarged view of the cage 37 and an optical module 40. The cage 37 is a cuboid housing made of metal. The optical module 40 is inserted into the cage 37. The optical module 40 is small form factor pluggable (SFP) and includes optical plug sockets 41 and 42 at one end and an edge interface 43 at the other end. The optical module 40 also contains a photoelectric transducer (not shown). The optical module 40 is inserted from the insertion opening 37a into the cage 37. The edge interface 43 is connected to the connector 38. The optical plug sockets 41 and 42 protrude from the cage 37.

The shield cover 32 is a flat housing having openings at the Y1 and Y2 sides.

The front panel 33 is a housing with an opening at the Y1 side. The front face (or the Y2 side) of the front panel 33 has a zigzag shape formed by a series of triangular shapes each having a side 33a and a side 33b. The side 33b nominally faces the Z2 direction and has an opening 33c.

As shown in FIG. 4, the front panel 33 is attached to the Y2 side of the printed board 31 so as to cover the Y2 side of the printed board 31. The insertion opening 37a of each cage 37 is inserted into a corresponding opening 33c and protrudes from a corresponding side 33b of the front panel 33.

The front panel 33 also includes a card lever 45 at the Z1 side and a card lever 46 at the Z2 side. The card levers 45 and 46 are turned and then pressed in the Y1 direction, in the final step of inserting the optical plug-in unit 30 into the subrack 2, to apply a strong force in the Y1 direction to the optical plug-in unit 30. Also, the card levers 45 and 46 are pulled and turned, in the first step of removing the optical plug-in unit 30 from the subrack 2, to apply a strong force in the Y2 direction to the optical plug-in unit 30.

The optical module 40 is inserted into the cage 37 to form an optical interface. The optical plug-in unit 30 is configured so that a row of optical interfaces are provided on the Y2 side face (front face).

As shown in FIG. 1, when being installed, the optical plug-in unit 30 is inserted from the insertion opening 4 into the subrack 2 guided by the upper guide rail 5 and the lower guide rail 6. The optical plug-in unit 30 is then pressed into the final position through the operation of card levers 45 and 46. At the final position, the connector 34 of the optical plug-in unit 30 is connected to a connector on the backplane 3.

An operator inserts an optical module 40 into a cage 37 from the front side of the electronic apparatus 1 and then inserts the plug at the end of a fiber optic cable 50, which is coming into the electronic apparatus 1 from the outside, into the optical plug socket 41 or 42. An exemplary optical plug-in unit 30 according to an embodiment of the present invention can provide up to eight optical plug sockets. In other words, the optical plug-in unit 30 is configured so that up to eight fiber optic cables can be connected.

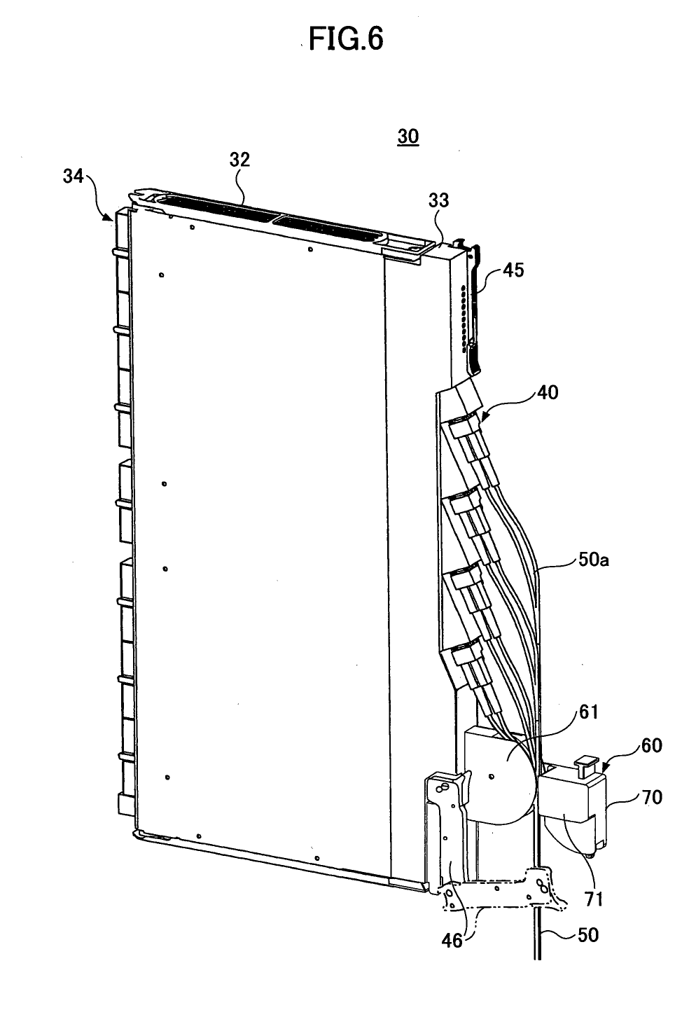

In FIG. 6, an optical module 40 is inserted in every cage 37, and a fiber optic cable 50 is connected to every optical plug socket 41 and every optical plug socket 42.

Since optical plug sockets 41 and 42 face obliquely downward, the fiber optic cables 50 are stretched out from the front face of the optical plug-in unit 30 in an obliquely downward direction.

An extra fiber optic cable length handling mechanism 60 of the optical plug-in unit 30 is described below. In the embodiments of the present invention, extra fiber optic cable length handling includes removing the slack in fiber optic cables and guiding fiber optic cables along a predetermined path.

As shown in FIGS. 2 and 4, the extra fiber optic cable length handling mechanism 60 is positioned close to the Z2 side on the front face of the front panel 33 of the optical plug-in unit 30. The extra fiber optic cable length handling mechanism 60 includes a first guiding member 61 fastened on the front panel 33 and a second guiding member 70 rotatably attached to the first guiding member 61.

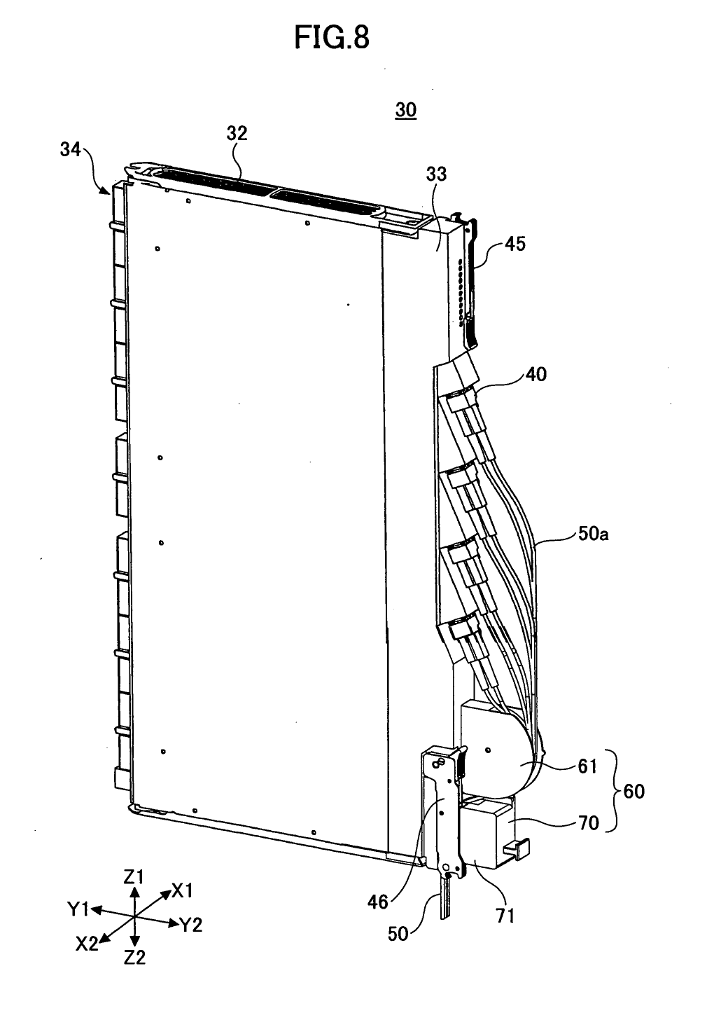

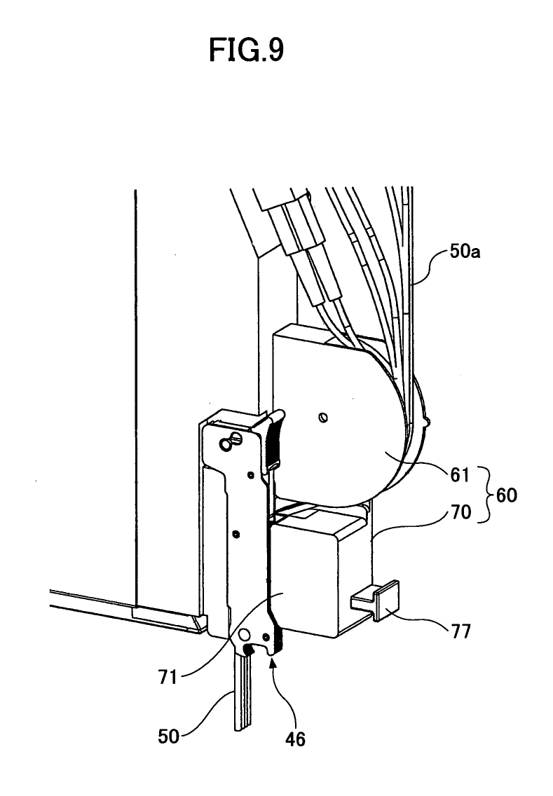

FIG. 8 is a perspective view of the optical plug-in unit 30, where fiber optic cables are guided along a path by the extra fiber optic cable length handling mechanism 60. FIG. 9 is an enlarged view of the extra fiber optic cable length handling mechanism 60 shown in FIG. 8.

The first guiding member 61 and the second guiding member 70 are preferably molded parts made of a material with a low friction coefficient such as polyacetal resin or Teflon (registered trademark)-coated parts, so that portions of their surfaces contacting fiber optic cables have a low sliding resistance.

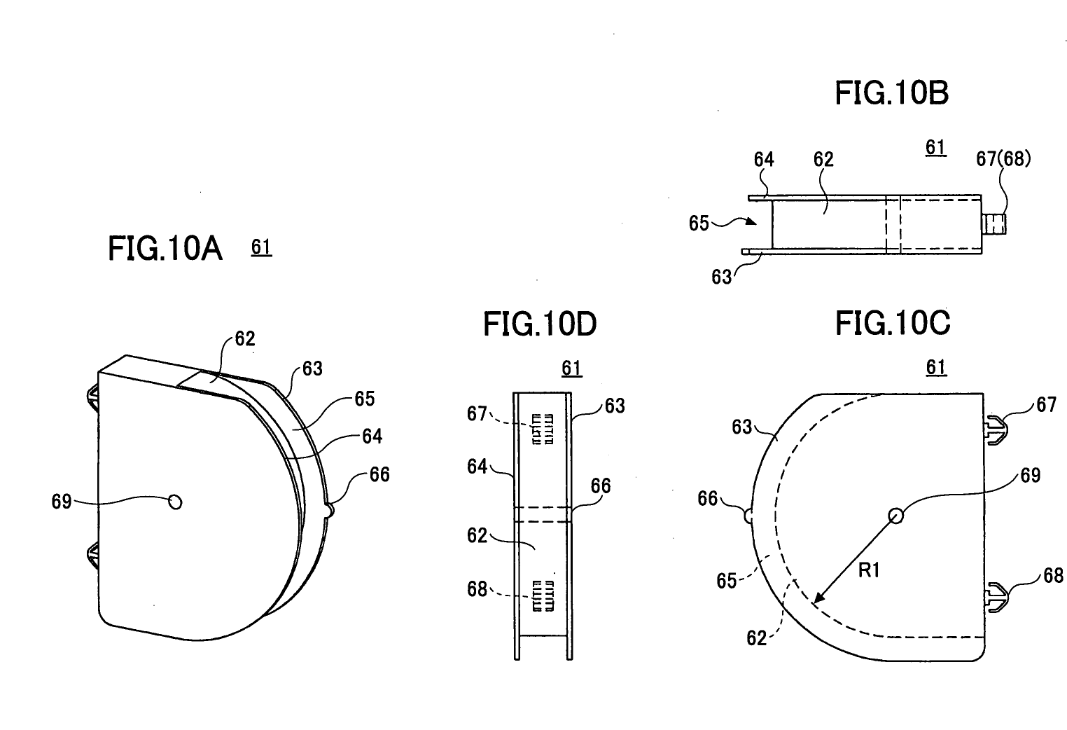

FIGS. 10A through 10D are drawings illustrating the first guiding member 61. The first guiding member 61 includes a circular arc surface 62 with radius R1 around a center hole 69, and a flange 63 at one side and a flange 64 at the other side of the circular arc surface 62. The flanges 63 and 64 form a gutter 65. The radius R1 is, for example, 25.4 mm (1 inch) and is preferably greater than the minimum bending radius of a fiber optic cable at which its transmission characteristics start deteriorating. A projection 66 serves as a lock for locking the second guiding member 70. As shown in FIG. 4B, the first guiding member 61 is fastened on the front face of the front panel 33 by inserting claw studs 67 and 68 into holes on the front panel 33. The first guiding member 61 protrudes from the front panel 33 in the Y2 direction.

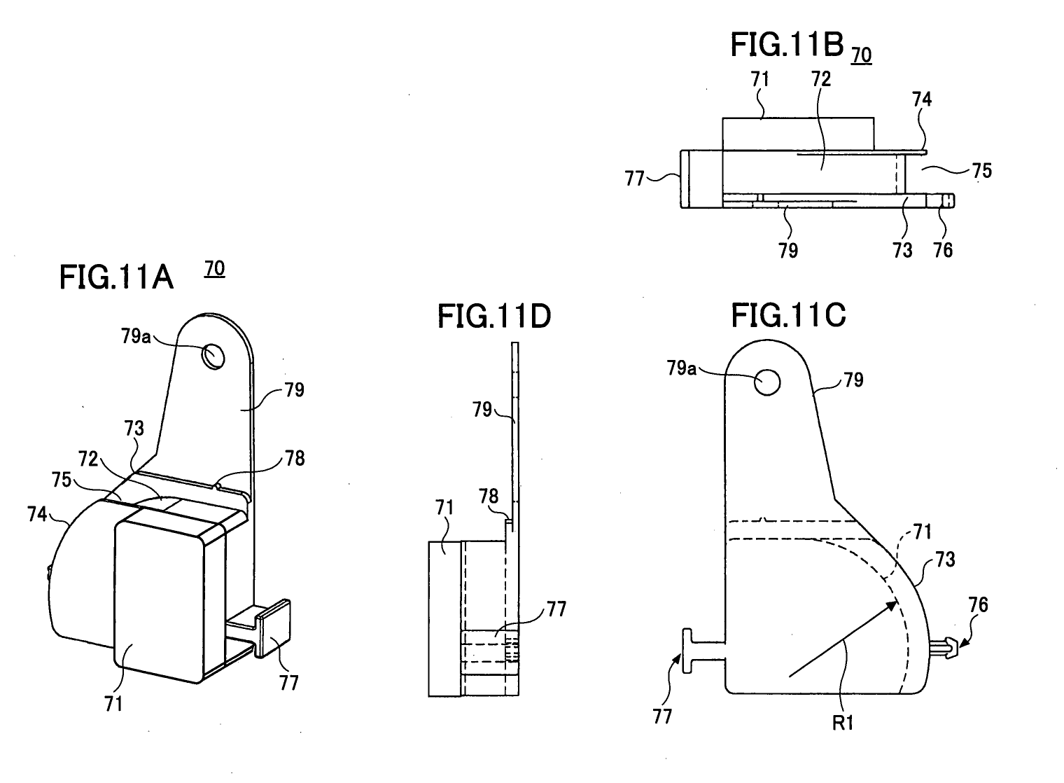

FIGS. 11A through 11D are drawings illustrating the second guiding member 70. The second guiding member 70 includes a circular arc surface 72 with radius R1, and a flange 73 at one side and a flange 74 at the other side of the circular arc surface 72. The flanges 73 and 74 form a gutter 75. An arm 79 protrudes from the flange 73. The arm 79 has a hole 79a. The second guiding member 70 further includes an overhang 71, a tongue 76, a finger grip 77, and a projection 78 for locking.

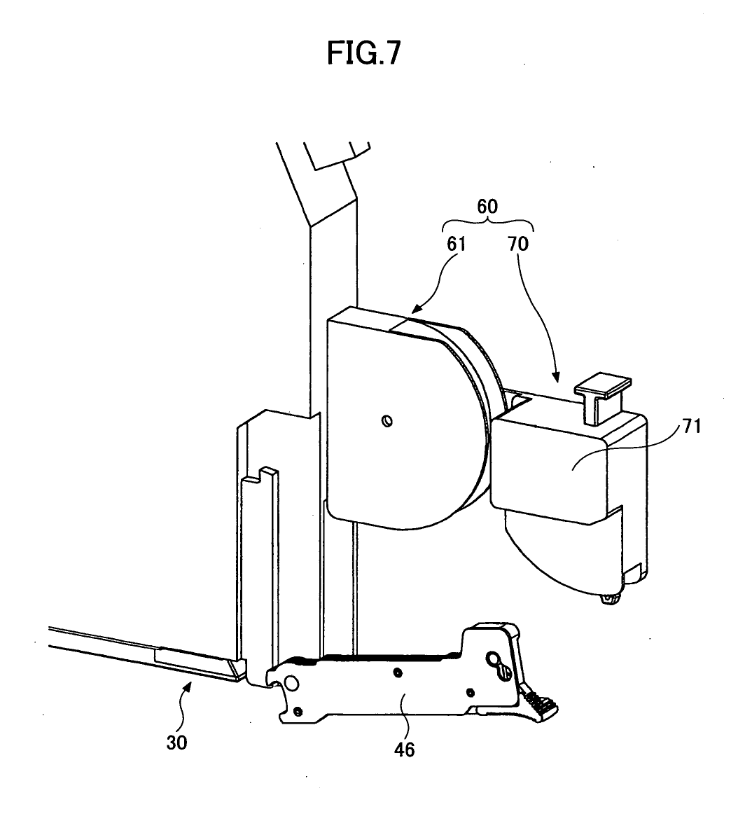

The second guiding member 70 is attached to the first guiding member 61 by inserting a shaft protruding from the center hole 69 of the first guiding member 61 into the hole 79a. The second guiding member 70 can be rotated around the center hole 69 of the first guiding member 61 between a position at the Y2 side of the first guiding member 61 shown in FIGS. 6 and 7 and a position at the Z2 side of the first guiding member 61 shown in FIGS. 8 and 9. The second guiding member 70 may be further rotated to the Z1 side of the first guiding member 61 beyond the position shown in FIGS. 6 and 7.

Before extra fiber optic cable length handling, the second guiding member 70 is positioned at the Y2 side of the first guiding member 61 as shown in FIGS. 6, 7, and 12A, where the projection 78 engages the projection 66.

As shown in FIG. 4B, a locking part 80 for locking the tongue 76 is fastened to the front panel 33. The locking part 80 locks the tongue 76 when the tongue 76 is first pressed into the locking part 80, and unlocks the tongue 76 when it is pressed again further into the locking part 80.

Operation of the extra fiber optic cable length handling mechanism 60 is described below.

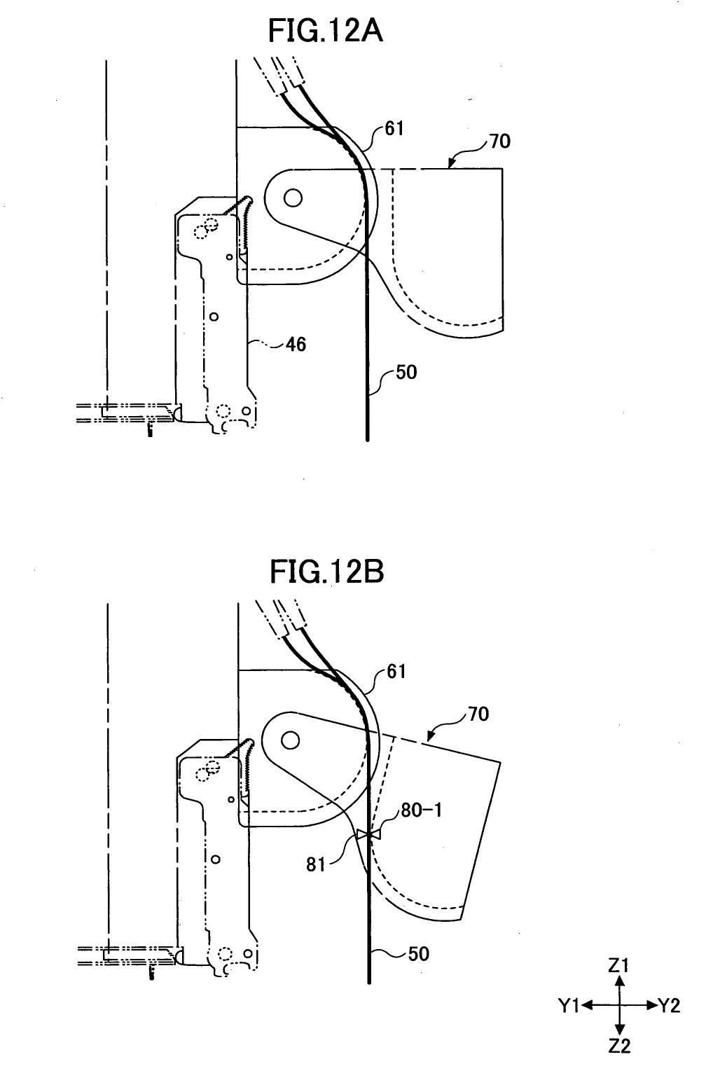

First, as shown in FIG. 12A, the fiber optic cables 50 stretching out from the front face of the optical plug-in unit 30 in an obliquely downward direction are placed in the gutter 65 of the first guiding member 61 and put through the space between the first guiding member 61 and the second guiding member 70.

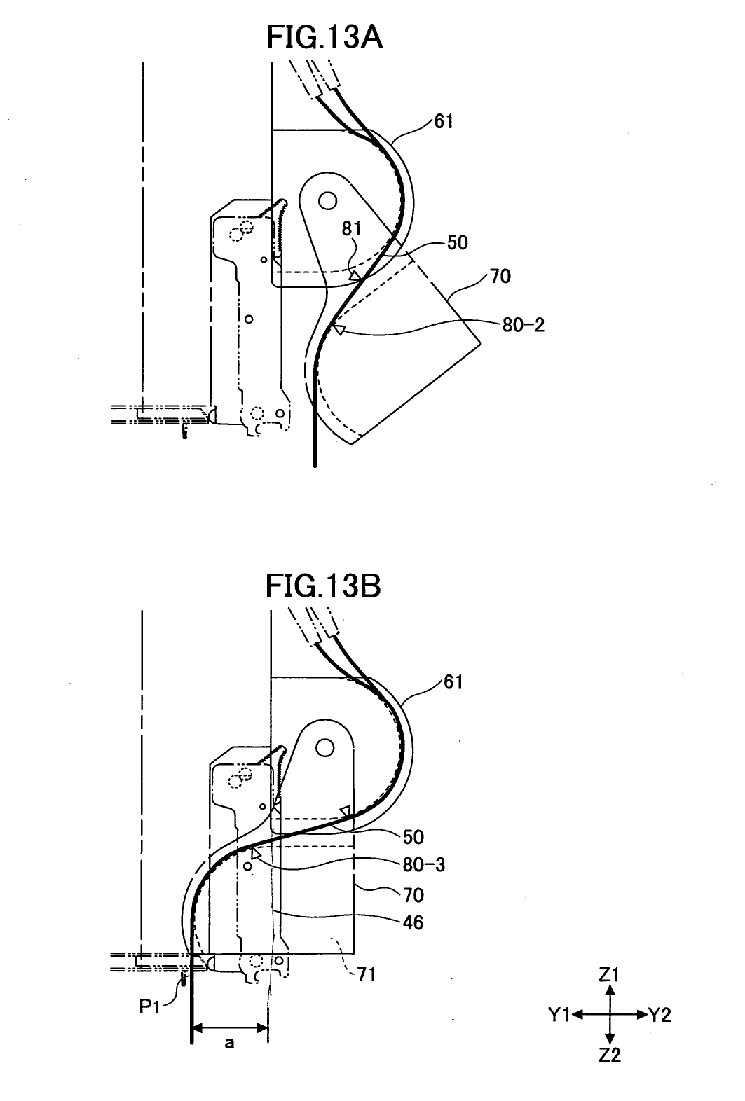

Next, the second guiding member 70 is pressed down and rotated about 90 degrees to the final position as shown in FIG. 13B. The second guiding member 70 is held in the position by the tongue 76 and the locking part 80.

When the second guiding member 70 is pressed down, the projection 78 passes over the projection 66. The second guiding member 70, when rotated to the position shown in FIG. 12B, contacts the fiber optic cables 50 being guided by the first guiding member 61 in the Z2 direction. When rotated further, the second guiding member 70 pushes the fiber optic cables 50 in the Y1 direction, thereby causing a part of the fiber optic cables 50 to be wound around the circular arc surface 62 of the first guiding member 61 and causing another part of the fiber optic cables 50 to be wound around the circular arc surface 72 of the second guiding member 70 in an opposite circumferential direction.

The second guiding member 70 is moved into the final position just under the first guiding member 61 as shown in FIG. 13B and locked. As shown in FIG. 13B, with the second guiding member 70 at the final position, a part of each of the fiber optic cables 50 is wound around the circular arc surface 62 of the corresponding first guiding member 61 and another part of each of the fiber optic cables 50 is wound around the circular arc surface 72 of the corresponding second guiding member 70, those parts forming an inverted S-shaped curve. The fiber optic cables 50 come out from a position P1 of the front panel 33, the position P1 being located at a length “a” in the Y1 direction from the front face of the front panel 33. The position P1 is located just above the duct 7.

Accordingly, the fiber optic cables 50 coming out from the front panel 33 in the Z2 direction go into the duct 7 and are laid along the duct 7 in the X1 or X2 direction. At this stage, the slack in a portion of the fiber optic cables 50 below the first guiding member 61 is removed. As described above, the fiber optic cables 50 are guided by the extra fiber optic cable length handling mechanism 60 along a predetermined path. Thus, the fiber optic cables 50 can be neatly stored with a simple operation. After completing extra fiber optic cable length handling, the fiber optic cables 50 on the front face of the optical plug-in unit 30 appear as shown in FIG. 8.

Each curve in the inverted S-shaped curve has the radius R1 which is greater than the minimum bending radius of a fiber optic cable, and therefore the transmission characteristics of the fiber optic cables 50 do not deteriorate.

The flanges 63 and 64 prevent the fiber optic cables 50 from coming off the circular arc surface 62 in the X1 or X2 direction; the flanges 73 and 74 prevent the fiber optic cables 50 from coming off the circular arc surface 72 in the X1 or X2 direction. These structures keep the fiber optic cables 50 within the gutters 65 and 75, causing the fiber optic cables 50 to form an inverted S-shaped curve.

Pressing the second guiding member 70 positioned as shown in FIG. 8 further in the Y1 direction causes the locking part 80 to unlock the tongue 76, thereby allowing the second guiding member 70 to be rotated in the Y2 direction.

Next, the force applied to the fiber optic cables 50 during extra fiber optic cable length handling is described.

In FIG. 12B, a triangular mark 80-1 indicates a point on the second guiding member 70, at which point the second guiding member 70 first contacts the fiber optic cables 50. A triangular mark 81 indicates a point in the fiber optic cables 50, at which point the fiber optic cables 50 first contact the second guiding member 70. As the second guiding member 70 rotates nominally downward, the point indicated by the triangular mark 80-1 moves approximately in the Z2 direction. In FIG. 13A, the point is in a position indicated by a triangular mark 80-2. In the final stage as shown in FIG. 13B, the point is in a position indicated by a triangular mark 80-3. This means that the circular arc surface 72 of the second guiding member 70 rubs the fiber optic cable 50 when being moved. As a result, a pulling force is applied to the fiber optic cables 50. Since the surface of the circular arc surface 72 has a low friction coefficient, the pulling force applied to the fiber optic cables 50 is not so strong as to harm the fiber optic cables 50.

Another function provided by the second guiding member 70 is described below.

The optical plug-in unit 30 is preferably pulled out from the subrack 2 after the fiber optic cables 50 are released from the extra fiber optic cable length handling mechanism 60 (or more preferably, after the fiber optic cables 50 are removed from the optical modules 40). Pulling out the optical plug-in unit 30 before releasing the fiber optic cables 50 from the extra fiber optic cable length handling mechanism 60 may place too much strain on the fiber optic cables 50 and may damage them.

As shown in FIG. 9, when the second guiding member 70 is in the final position, the overhang 71 locks the card lever 46 in the upright position, thereby preventing the operation of the card lever 46.

Such a configuration described above prevents the optical plug-in unit 30 from being pulled out by an unintentional operation of the card lever 46 before the fiber optic cables 50 are released from the extra fiber optic cable length handling mechanism 60, thereby protecting the fiber optic cables 50.

In FIG. 1, a protective cover 90 is attached to the front panel 33 of an optical plug-in unit 30 to cover the fiber optic cables 50 and the first guiding member 61 of the extra fiber optic cable length handling mechanism 60, where the fiber optic cables 50 are guided and stored by the extra fiber optic cable length handling mechanism 60.

### 2. Second Embodiment

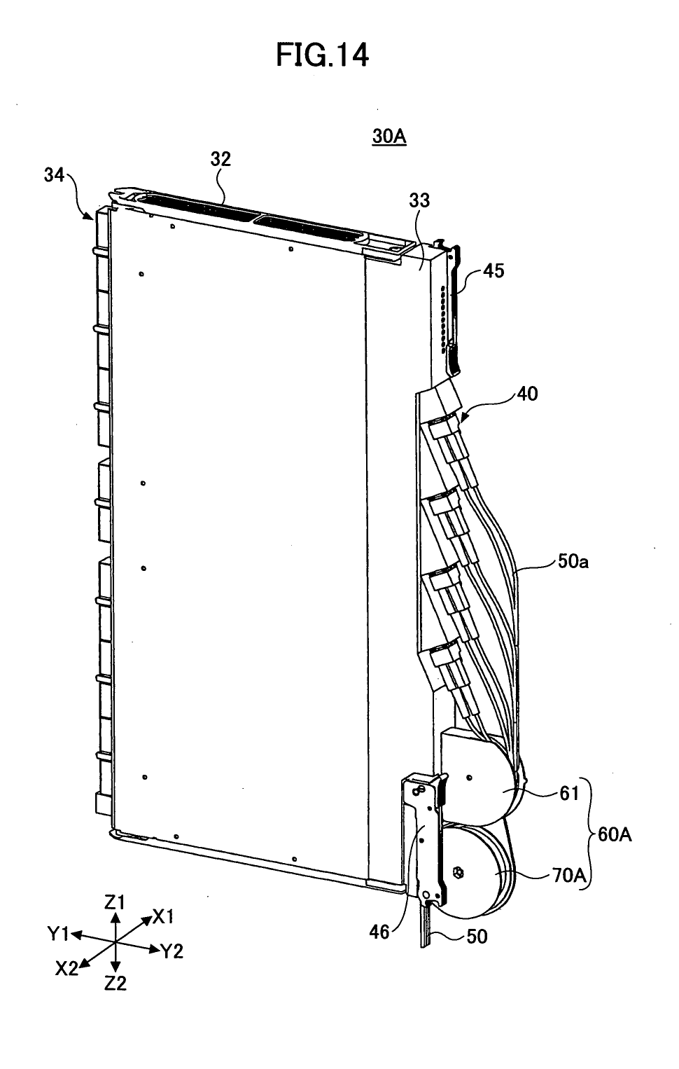

FIG. 14 is a perspective view of an optical plug-in unit 30A according to the second embodiment of the present invention. The optical plug-in unit 30A includes an extra fiber optic cable length handling mechanism 60A in place of the extra fiber optic cable length handling mechanism 60 of the optical plug-in unit 30. The extra fiber optic cable length handling mechanism 60A includes a second guiding member 70A in place of the second guiding member 70 of the extra fiber optic cable length handling mechanism 60.

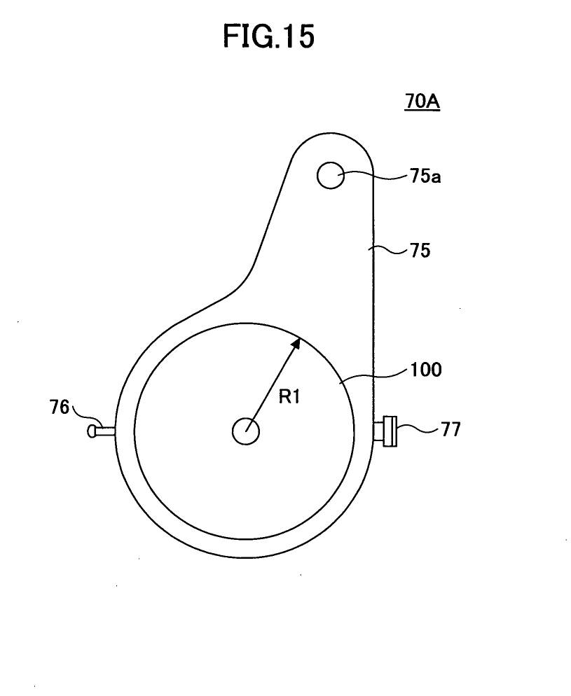

FIG. 15 is an enlarged view of the second guiding member 70A. The second guiding member 70A includes a roller 100 with radius R1.

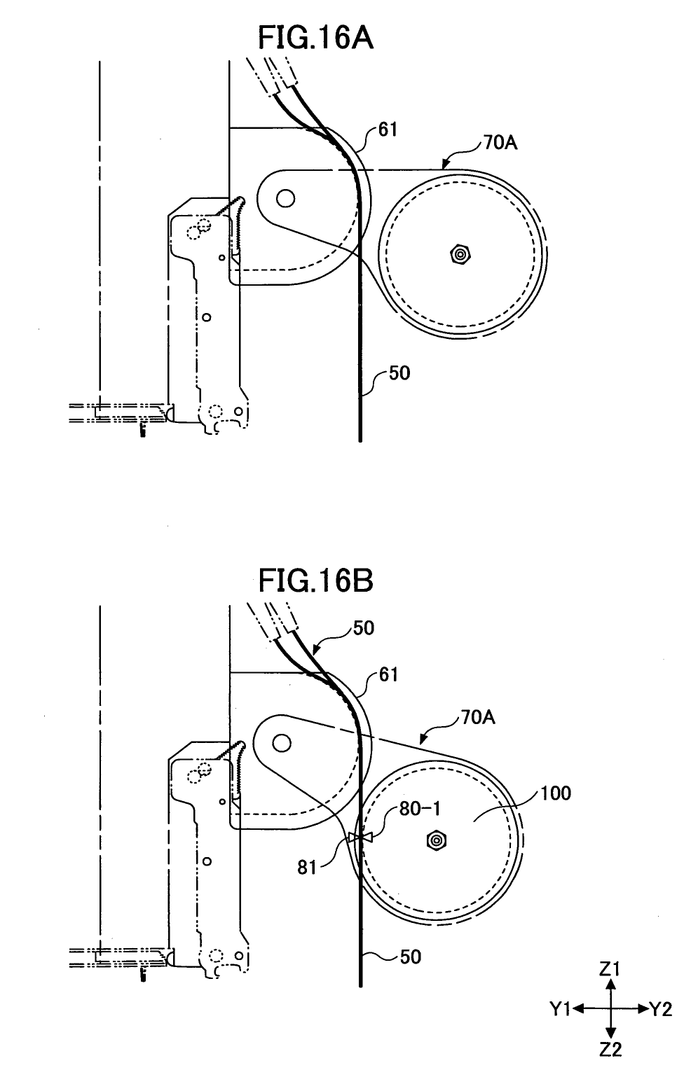

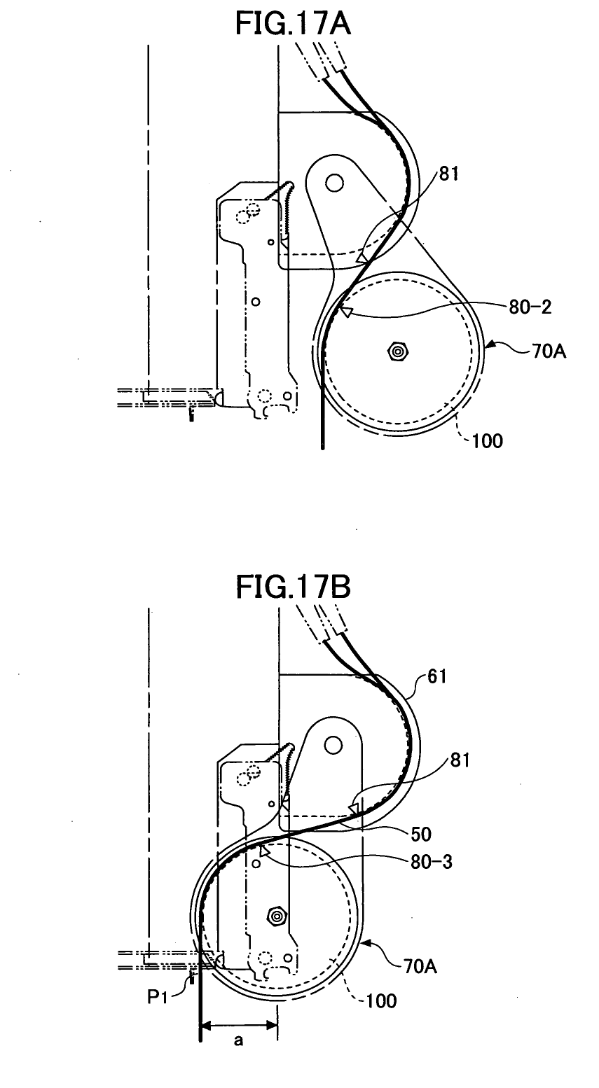

As shown in FIGS. 16A through 17B, the extra fiber optic cable length handling mechanism 60A is operated by rotating the second guiding member 70A. When the second guiding member 70A is rotated as shown in FIGS. 16A, 17A, and 17B, the roller 100 pushes the fiber optic cables 50 and in turn the roller 100 is rotated clockwise by the fiber optic cables 50. Therefore, no pulling force is applied to the fiber optic cables 50.

### 3. Third Embodiment

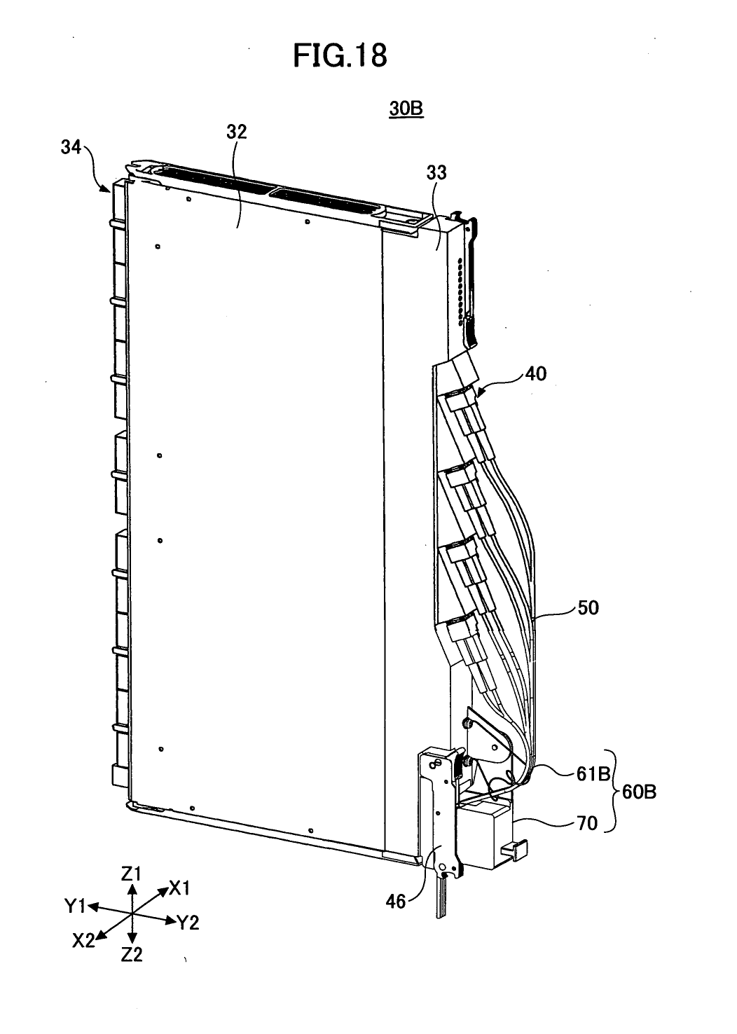

FIG. 18 is a perspective view of an optical plug-in unit 30B according to the third embodiment of the present invention. The optical plug-in unit 30B includes an extra fiber optic cable length handling mechanism 60B in place of the extra fiber optic cable length handling mechanism 60 of the optical plug-in unit 30. The extra fiber optic cable length handling mechanism 60B includes a first guiding member 61B in place of the first guiding member 61 of the extra fiber optic cable length handling mechanism 60.

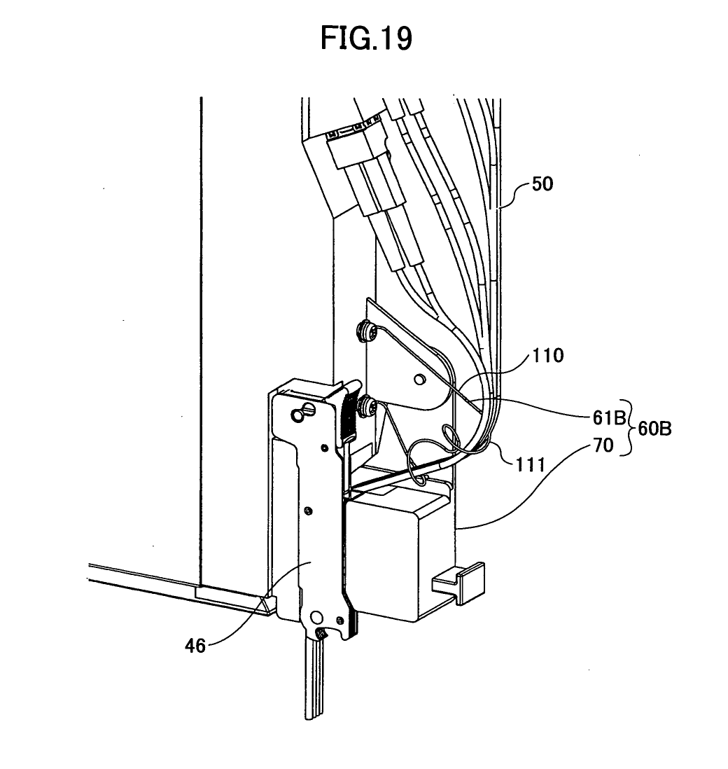

FIG. 19 is an enlarged view of the first guiding member 61B. The first guiding member 61B is formed by bending a steel wire 110 and includes a fiber optic cable guiding part 111 for guiding the fiber optic cables 50. The fiber optic cables 50 are guided through the fiber optic cable guiding part 111.

When an operator's finger touches the first guiding member 61B, it bends flexibly; when the operator's finger moves away, it returns to its original shape. Therefore, the first guiding member 61B does not hamper the operation of the optical plug-in unit 30B and does not hurt an operator.

The present invention is not limited to the specifically disclosed embodiments, and variations and modifications may be made without departing from the scope of the present invention.

The present application is based on Japanese Priority Application No. 2006-100587 filed on Mar. 31, 2006 with the Japanese Patent Office, the entire contents of which are hereby incorporated by reference.

What is claimed is:

1. A plug-in unit to be installed in a subrack and including on a front face at least one optical interface to which a fiber optic cable is connected, comprising:
an extra fiber optic cable length handling mechanism, positioned on the front face below the optical interface, for handling the fiber optic cable.

2. The plug-in unit as claimed in claim 1, wherein the extra fiber optic cable length handling mechanism includes a movable guiding member for guiding the fiber optic cable along a predetermined path.

3. The plug-in unit as claimed in claim 1, wherein the extra fiber optic cable length handling mechanism includes
a first guiding member fastened to the plug-in unit and protruding from the front face of the plug-in unit, and
a second guiding member movably attached to the plug-in unit and being movable to a position below the first guiding member, wherein moving the second guiding member into the position below the first guiding member causes the first guiding member and the second guiding member to guide the fiber optic cable along a predetermined path.

4. The plug-in unit as claimed in claim 3, wherein the second guiding member is rotatably attached to the first guiding member.

5. The plug-in unit as claimed in claim 3, wherein the second guiding member is rotatably attached to the first guiding member and a portion of the second guiding member contacting the fiber optic cable has a low sliding resistance.

6. The plug-in unit as claimed in claim 3, wherein the second guiding member is rotatably attached to the first guiding member and includes a roller for guiding the fiber optic cable.

7. The plug-in unit as claimed in claim 3, wherein the first guiding member is formed by bending a steel wire and includes a fiber optic cable guiding part for guiding the fiber optic cable.

8. The plug-in unit as claimed in claim 3, further comprising:
a card lever used to pull out the plug-in unit from the subrack, wherein the second guiding member moved into the position below the first guiding member locks the card lever.

9. The plug-in unit as claimed in claim 1, further comprising:
a protective cover for covering the fiber optic cable and the extra fiber optic cable length handling mechanism.

10. An electronic apparatus comprising:
a subrack including a cable duct positioned below a plug-in unit insertion opening; and
a plurality of the plug-in units as claimed in claim 1 installed side by side in the subrack, wherein the fiber optic cables stretching out from the plug-in units are guided by the extra fiber optic cable length handling mechanisms into the cable duct.
